(19) United States
(12) Patent Application Publication
(10) Pub. No.: US 2022/0158476 A1
(43) Pub. Date: May 19, 2022

(54) CHARGING MANAGEMENT METHOD AND SYSTEM FOR AUTOMOTIVE ELECTRONIC SUPER CAPACITOR

(71) Applicant: SHANGHAI TIMI MOTOR TECHNOLOGY CO., LTD, Shanghai (CN)

(72) Inventors: Xianhui ZHANG, Shanghai (CN); Haibo XUN, Shanghai (CN); Qiufan YIN, Shanghai (CN); Yongcong MO, Shanghai (CN)

(73) Assignee: SHANGHAI TIMI MOTOR TECHNOLOGY CO., LTD, Shanghai (CN)

(21) Appl. No.: 17/588,300

(22) Filed: Jan. 30, 2022

Related U.S. Application Data
(63) Continuation of application No. PCT/CN2020/130946, filed on Nov. 23, 2020.

(30) Foreign Application Priority Data
Nov. 25, 2019 (CN) 201911166729.5

(51) Int. Cl. H02J 7/34

(52) U.S. Cl. CPC H02J 7/345

(57) ABSTRACT

A charging management method for an automotive electronic super capacitor includes: detecting a voltage difference between a charging power supply and a super capacitor, and comparing the voltage difference with a first threshold voltage and a second threshold voltage, wherein the first threshold voltage is greater than the second threshold voltage; according to a comparison result, by adopting constant-current charging and controlling a unidirectional conduction module to turn on, causing the charging power supply to charge the super capacitor through a charging module until a voltage across the super capacitor reaches a voltage of the charging power supply; and turning off the charging module so that a low voltage difference is avoided in which case the super capacitor is discharged to the charging power supply through the charging module.

### CROSS REFERENCE TO THE RELATED APPLICATIONS

This application is the continuation application of International Application No. PCT/CN2020/130946, filed on Nov. 23, 2020, which is based upon and claims priority to Chinese Patent Application No. 201911166729.5, filed on Nov. 25, 2019, the entire contents of which are incorporated herein by reference.

### TECHNICAL FIELD

The present disclosure relates to the technical field of charging management and particularly to a charging management method and system for an automotive electronic super capacitor.

### BACKGROUND

With the cost reduction of super capacitors, their usage is becoming more and more popular, and the commercial value of their management circuits is becoming more and more significant. The charging and discharging circuits for super capacitors need to meet both the performance requirements and the price and volume requirements. Therefore, a variety of charging management schemes and circuits have emerged.

The conventional super capacitor charging circuits are in buck topologies, which require the input voltage to be 0.7 V to 1.5 V higher than the output voltage. However, for the application of super capacitors, in the application in a vehicle-mounted system, the output voltage is expected to be equal to the input voltage, and if the input voltage is suddenly reduced during the charging process, the current will flow in the reverse direction. Since the super capacitor can be equivalent to a power supply after being charged, in this case the buck topology becomes a reverse Boost structure, and the super capacitor will be discharged in the reverse direction, which will easily cause damage to power devices such as MOSFET tubes. Therefore, there is an urgent need for a control strategy that can effectively ensure that the buck topology used during the charging of super capacitors can be charged unidirectionally.

### SUMMARY

The present disclosure provides a charging management method and system for an automotive electronic super capacitor, which solve the problem that the existing charging circuits for super capacitors are prone to reverse discharging, which will damage power devices such as Metal-Oxide-Semiconductor Field-Effect Transistor (MOSFET) tubes in the circuits.

The present disclosure can be implemented by the following technical schemes:

A charging management method for an automotive electronic super capacitor, comprising: detecting a voltage difference between a charging power supply and a super capacitor, and comparing the voltage difference with a first threshold voltage and a second threshold voltage, wherein the first threshold voltage is greater than the second threshold voltage; according to a comparison result, by adopting constant-current charging and controlling a unidirectional conduction module to turn on, causing the charging power supply to charge the super capacitor through a charging module until a voltage across the super capacitor reaches a voltage of the charging power supply; and turning off the charging module so that a low voltage difference is avoided in which case the super capacitor is discharged to the charging power supply through the charging module.

Further, when the super capacitor is in a pure charged state, if the voltage difference is greater than the first threshold voltage or is between the first threshold voltage and the second threshold voltage, large-current charging is adopted until the voltage difference is less than the second threshold voltage, then the unidirectional conduction module is turned on and small-current charging is adopted until the voltage across the super capacitor reaches the voltage of the charging power supply, then the charging module and the unidirectional conduction module are turned off; and when the voltage difference is less than the second threshold voltage, the unidirectional conduction module is turned on and small-current charging is adopted until the voltage across the super capacitor reaches the voltage of the charging power supply, then the charging module and the unidirectional conduction module are turned off; and

when the super capacitor is in a charged state during discharging, if the voltage difference is less than the second threshold voltage, the charging module and the unidirectional conduction module are kept turned off until the voltage difference is greater than the second threshold voltage, then the unidirectional conduction module and the charging module are turned on and small-current charging is adopted, and if the voltage difference tends to decrease, until the voltage across the super capacitor reaches the voltage of the charging power supply, the charging module and the unidirectional conduction module are turned off; and if the voltage difference tends to increase and is greater than the first threshold voltage, the unidirectional conduction module is turned off and large-current charging is adopted until the voltage difference is less than the second threshold voltage, then the unidirectional conduction module is turned on again and small-current charging is adopted until the voltage across the super capacitor reaches the voltage of the charging power supply, then the charging module and the unidirectional conduction module are turned off.

Further, the first threshold voltage and the second threshold voltage are adjusted according to different temperatures of the super capacitor, with the difference between the two tending to decrease as the temperature increases.

Further, when the temperature is higher than 20° C., the difference between the two is set to 0.7-0.85 V, and when the temperature is lower than 20° C., the difference between the two is set to 0.85-1.5 V.

Further, the difference between the two is calculated using the following equation, and then the first threshold voltage and the second threshold voltage are adjusted according to the difference,

ΔV=0.9−0.01*T

where ΔV denotes the difference between the first threshold voltage and the second threshold voltage, and T denotes the temperature of the super capacitor.

Further, the charging module is in a Buck topology, the second threshold voltage is set according to a voltage drop corresponding to the charging module when a maximum duty ratio is reached, and the first threshold voltage is set according to the second threshold voltage and the sum of line voltage drops corresponding to the super capacitor and a circuit except the charging module.

A charging management system based on the above-mentioned charging management method for an automotive electronic super capacitor, comprising: a processor connected to a temperature sensor, a charging module, and a voltage detection module, wherein the charging module is connected to a switch control module and a unidirectional conduction module, the switch control module is used to control the turn-on and turn-off of the charging module, the charging module is used to implement charging of the super capacitor from the charging power supply, the temperature sensor is configured to detect the temperature inside the super capacitor, the unidirectional conduction module is configured to control unidirectional charging of the super capacitor by the charging power supply through the charging module, and the voltage detection module is configured to detect voltages across the charging power supply and the super capacitor respectively in real time.

Further, the switch control module is implemented using a MOS field effect tube, the unidirectional conduction module is implemented using a body diode of the MOS field effect tube itself, and the charging module is in a Buck topology, and

the processor configured to receive the voltages across the charging power supply and the super capacitor, calculate a voltage difference between the two, and determine whether the super capacitor is in a pure charged state or in a charged state during discharging, wherein:

when it is in the pure charged state, if the voltage difference is greater than a first threshold voltage or is between a first threshold voltage and a second threshold voltage, the MOS field effect tube is turned on, and a large-current charging mode is adopted and the charging power supply is controlled through the charging module to charge the super capacitor until the voltage difference is less than the second threshold voltage, then the MOS field effect tube is turned off and the body diode is conducted, and a small-current charging mode is adopted and the charging power supply is controlled through the charging module to charge the super capacitor until the voltage across the super capacitor reaches the voltage of the charging power supply, and then the charging module is turned off; and if the voltage difference is less than the second threshold voltage, the MOS field effect tube is turned off and the body diode is conducted, and the small-current charging mode is adopted and the charging power supply is controlled through the charging module to charge the super capacitor until the voltage across the super capacitor reaches the voltage of the charging power supply, and then the charging module is turned off; and

when it is in the charged state during discharging, if the voltage difference is less than the second threshold voltage, the charging module is kept turned off until the voltage difference is greater than the second threshold voltage, then the charging module is turned on and small-current charging is adopted, and if the voltage difference tends to decrease, until the voltage across the super capacitor reaches the voltage of the charging power supply, the charging module is turned off; and if the voltage difference tends to increase and is greater than the first threshold voltage, the MOS field effect tube is turned on, and large-current charging is adopted until the voltage difference is less than the second threshold voltage, then the MOS field effect tube is turned off and the body diode is conducted, and small-current charging is adopted until the voltage across the super capacitor reaches the voltage of the charging power supply, and then the charging module is turned off.

The beneficial technical effects of the present disclosure are as follows:

A voltage difference between a charging power supply and a super capacitor is detected, and the voltage difference is compared with a first threshold voltage and a second threshold voltage; and according to a comparison result, by adopting constant-current charging and controlling a unidirectional conduction module to turn on, the charging power supply is caused to charge the super capacitor through a charging module until a voltage across the super capacitor reaches a voltage of the charging power supply. In this way, a low voltage difference is avoided in which case the super capacitor is discharged to the charging power supply through the charging module, which will cause damage to other power devices in the circuit; and at the same time, the voltage across the super capacitor can reach the voltage of the charging power supply, thus achieving the effect of voltage following to meet the needs of automotive electronics applications.

### BRIEF DESCRIPTION OF THE DRAWINGS

FIG. 1 is a schematic diagram of the overall process of the present disclosure;

FIG. 2 is a schematic diagram of the corresponding adjustment of a first threshold voltage and a second threshold voltage with changes in temperature when a nonlinear control strategy is adopted;

FIG. 3 is a schematic diagram of the corresponding adjustment of a first threshold voltage and a second threshold voltage with changes in temperature when a linear control strategy is adopted in the present disclosure;

FIG. 4 is a schematic diagram of a circuit of the present disclosure with the addition of a MOS field effect tube with a body diode to the conventional charging circuit in the buck topology;

FIG. 5 is a block diagram of a circuit of a series-controlled charging management system of the present disclosure; and

FIG. 6 is a block diagram of a circuit of a parallel-controlled charging management system of the present disclosure.

### DETAILED DESCRIPTION OF THE EMBODIMENTS

The specific implementations of the present disclosure are described in detail below in conjunction with the accompanying drawings and preferred embodiments.

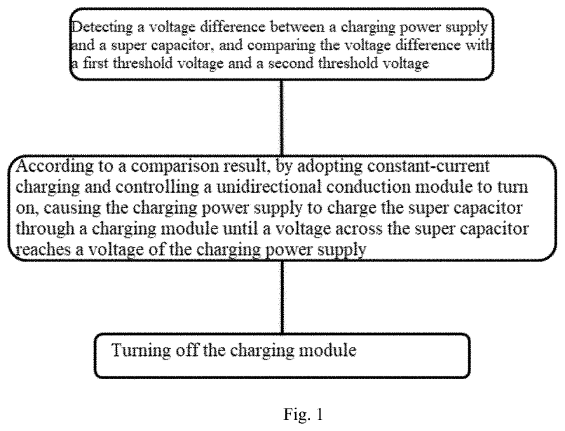

With reference to FIG. 1, the present disclosure provides a charging management method for an automotive electronic super capacitor, mainly including: detecting a voltage difference between a charging power supply and a super capacitor, and comparing the voltage difference with a first threshold voltage and a second threshold voltage, where the first threshold voltage is greater than the second threshold voltage; according to a comparison result, by adopting constant-current charging and controlling a unidirectional conduction module to turn on, causing the charging power supply to charge the super capacitor through a charging module until a voltage across the super capacitor reaches a voltage of the charging power supply; and turning off the charging module. In this way, when the voltage difference between the charging power supply and the super capacitor is small, the unidirectional conduction module is turned on and small-current decreasing charging is adopted to avoid the discharging of the super capacitor to the charging power supply through the charging module, which will cause damage to other power devices in the circuit; and at the same time, the voltage across the super capacitor can reach the voltage of the charging power supply, thus achieving the effect of voltage following to meet the needs of automotive electronics applications.

Specifically, when the super capacitor is in a pure charged state, if the voltage difference is greater than the first threshold voltage or is between the first threshold voltage and the second threshold voltage, large-current charging is adopted until the voltage difference is less than the second threshold voltage, then the unidirectional conduction module is turned on and small-current charging is adopted until the voltage across the super capacitor reaches the voltage of the charging power supply, then the charging module and the unidirectional conduction module are turned off; and when the voltage difference is less than the second threshold voltage, the unidirectional conduction module is turned on and small-current charging is adopted until the voltage across the super capacitor reaches the voltage of the charging power supply, then the charging module and the unidirectional conduction module are turned off.

When the super capacitor is in a charged state during discharging, if the voltage difference is less than the second threshold voltage, the charging module and the unidirectional conduction module are kept turned off until the voltage difference is greater than the second threshold voltage, then the unidirectional conduction module and the charging module are turned on and small-current charging is adopted. If the discharging current is less than the charging current at this time, the voltage across the super capacitor will keep rising and the voltage difference will tend to decrease, then small-current charging can be continued until the voltage across the super capacitor reaches the voltage of the charging power supply, and then the charging module and the unidirectional conduction module is turned off. However, if the discharging current is greater than the charging current, the voltage across the super capacitor will keep decreasing and the voltage difference tends to increase, until it is greater than the first threshold voltage, then the unidirectional conduction module is turned off and large-current charging is adopted until the voltage difference is less than the second threshold voltage, then the unidirectional conduction module is turned on and small-current charging is adopted until the voltage across the super capacitor reaches the voltage of the charging power supply, then the charging module and the unidirectional conduction module are turned off.

Considering the influence of temperature on the super capacitor, the temperature of the super capacitor can be detected first before the above control approach is applied. When the temperature is higher than 65° C., charging and discharging of the super capacitor is prohibited; while only when the temperature is lower than 65° C., the above method can be used for charging management.

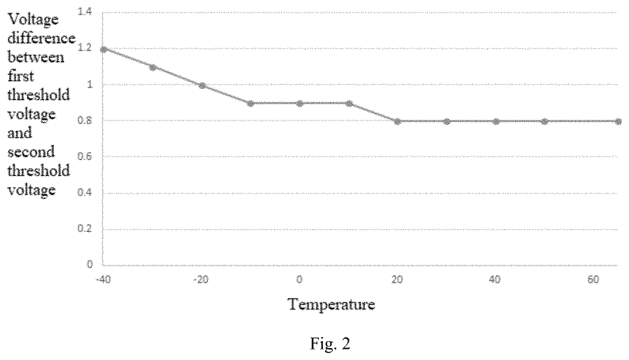

The charging module may be in a Buck topology, the second threshold voltage is set according to a voltage drop corresponding to the charging module when a maximum duty ratio is reached, and the first threshold voltage is set according to the second threshold voltage and the sum of line voltage drops corresponding to the super capacitor and a circuit except the charging module. Meanwhile, considering the influence of temperature on the internal resistance of the super capacitor, the first threshold voltage and the second threshold voltage may also be adjusted according to different temperatures of the super capacitor, with the difference between the two tending to decrease as the temperature increases. It is experimentally verified that a nonlinear control strategy may be used. With reference to FIG. 2, when the temperature is higher than 20° C., the difference between the two is set to 0.7-0.85 V, preferably 0.8 V, and when the temperature is lower than 20° C., the difference between the two is set to 0.85-1.5 V, as follows: the voltage across the charging power supply is denoted as Vin, and the voltage across the super capacitor is denoted as Vout.

When the ambient temperature is higher than 20° C., the settings are as follows: if Vin−Vout is greater than the first threshold voltage of 1.6 V, the switch control module is turned on, and if Vin−Vout is less than the second threshold voltage of 0.8 V, the switch control module is turned off, while the unidirectional conduction module automatically starts to function.

When the ambient temperature is lower than 20° C., the difference between the first threshold voltage and the second threshold voltage is adjusted according to the detected temperature, and the specific control strategy is as follows:

When the ambient temperature is between −10° C. and 10° C., the settings are as follows: if Vin−Vout is greater than the first threshold voltage of 1.7 V, the switch control module is turned on, and if Vin−Vout is less than the second threshold voltage of 0.8 V, the switch control module is turned off, while the unidirectional conduction module automatically starts to function.

When the ambient temperature is between −20° C. and −10° C., the settings are as follows: if Vin−Vout is greater than the first threshold voltage of 1.8 V, the switch control module is turned on, and if Vin−Vout is less than the second threshold voltage of 0.8 V, the switch control module is turned off, while the unidirectional conduction module automatically starts to function.

When the ambient temperature is −30° C., the settings are as follows: if Vin−Vout is greater than the first threshold voltage of 1.9 V, the switch control module is turned on, and if Vin−Vout is less than the second threshold voltage of 0.8 V, the switch control module is turned off, while the unidirectional conduction module automatically starts to function.

When the ambient temperature is −40° C., the settings are as follows: if Vin−Vout is greater than the first threshold voltage of 2 V, the switch control module is turned on, and if Vin−Vout is less than the second threshold voltage of 0.8 V, the switch control module is turned off, while the unidirectional conduction module automatically starts to function.

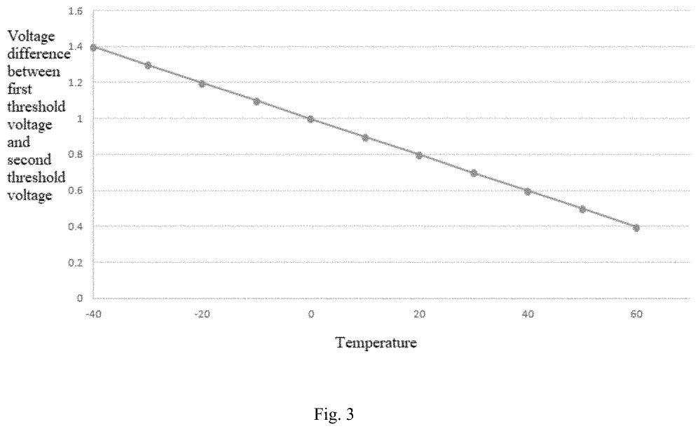

Alternatively, a linear control strategy may be used, thus facilitating the design of the computing program. With reference to FIG. 3, the difference between the two is calculated using the following equation, and then the first threshold voltage and the second threshold voltage are then adjusted according to the difference,

ΔV=0.9−0.01*T

where ΔV denotes the difference between the first threshold voltage and the second threshold voltage, and T denotes the temperature of the super capacitor.

According to the present disclosure, there is also provided a charging management system based on the charging management method for an automotive electronic super capacitor as described above. First, for the charging circuit for the super capacitor, the present disclosure adds a switch control module and a unidirectional conduction module to the conventional charging circuit in the buck topology. The switch control module is configured to control the turn-on and turn-off of the charging module. The unidirectional conduction module is configured to control the unidirectional charging of the super capacitor by the charging power supply through the charging module. Specifically, a MOS field effect tube with a body diode can be used, so that when the voltage across the super capacitor is low, the MOS field effect tube is turned on to reduce its power consumption and achieve constant-current charging of the charging circuit in the buck topology; and when the voltage across the super capacitor is close to the voltage of the charging power supply, the MOS field effect tube is turned off, and the unidirectional conduction function of the body diode inside the MOS field effect tube is utilized to realize the unidirectional transmission of current, so that the reverse Boost mode can be avoided where the charged super capacitor is discharged to the charging power supply, thus causing damage to other power devices in the circuit, and further, the devices can be saved to reduce the cost.

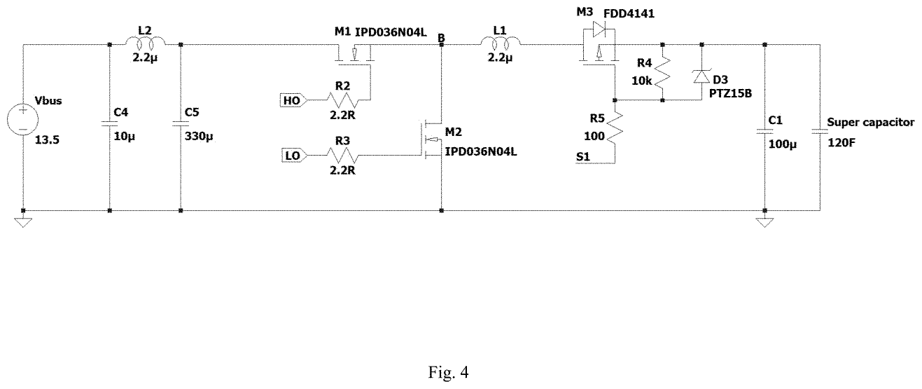

With reference to FIG. 4, the present disclosure adds a P-MOS field effect tube M3 with a body diode, resistors R4 and R5, and a Zener diode D3 to the output end of the conventional charging circuit in the buck topology, wherein the drain of the P-MOS field effect tube M3 is connected to the output end, the gate is connected to resistor R5, and the source is connected respectively to one end of resistor R4 and Zener diode D3 of which the other end is respectively connected to the gate; the input end of the charging circuit is connected to the charging power supply through a n-type filter consisting of capacitors C4 and C5 and inductor L2; and the two ends of the super capacitor are connected to the output end of the charging circuit through filtering capacitor C1. Of course, an N-channel MOSFET may also be used instead of a P-channel MOSFET, but an additional 24 V power supply is required.

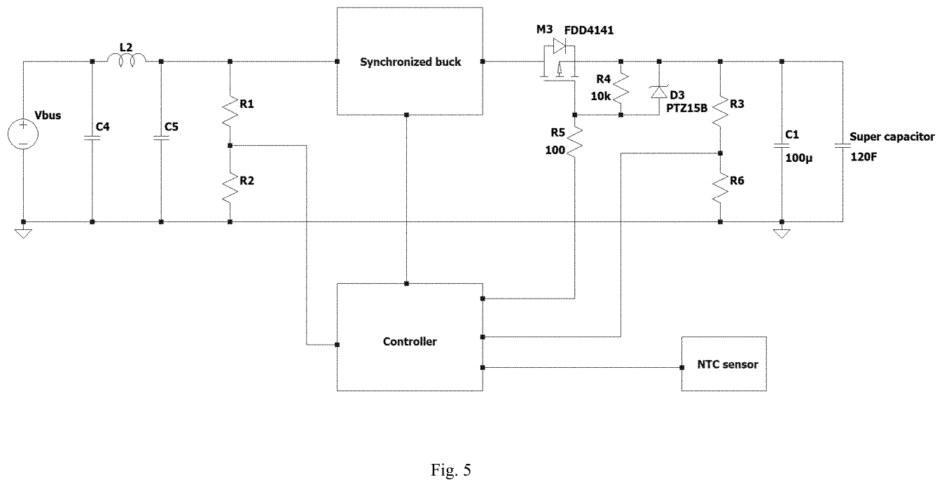

Secondly, in order to meet the needs of the vehicle-mounted system and facilitate the intelligent control of the above circuit, and also to enable the voltage across the super capacitor to reach the voltage of the charging power supply so as to achieve the function of voltage following, a processor, a temperature sensor, and a voltage detection module are added to the above circuit with reference to FIG. 5. The voltage detection module includes two parts, wherein one part consists of series-connected resistors R1 and R2, the two ends of which are connected to the output end of the π-type filter to detect the voltage across the charging power supply, and the other part consists of series-connected resistors R3 and R4, the two ends of which are connected to both ends of the filtering capacitor C1 to detect the voltage across of the super capacitor. The temperature sensor is implemented using an NTC sensor. The processor is connected to the temperature sensor, the charging module, and the voltage detection module, wherein the charging module is connected to a switch control module and a unidirectional conduction module, the switch control module is configured to control the turn-on and turn-off of the charging module, the charging module is used to implement charging of the super capacitor from the charging power supply, the temperature sensor is configured to detect the temperature inside the super capacitor, the unidirectional conduction module is configured to control unidirectional charging of the super capacitor by the charging power supply through the charging module, and the voltage detection module is configured to detect voltages across the charging power supply and the super capacitor respectively in real time.

The processor receives the voltages across the charging power supply and the super capacitor that are measured by the voltage detection module, calculates a voltage difference between the two, compares it with the first threshold voltage and the second threshold voltage, and determines whether the super capacitor is in a pure charged state or in a charged state during discharging.

When it is in a pure charged state, if the voltage difference is greater than the first threshold voltage or is between the first threshold voltage and the second threshold voltage, the MOS field effect tube is turned on, and a large-current charging mode is adopted and the charging power supply is controlled through the charging module to charge the super capacitor until the voltage difference is less than the second threshold voltage, then the MOS field effect tube is turned off and the body diode is conducted, and a small-current charging mode is adopted and the charging power supply is controlled through the charging module to charge the super capacitor until the voltage across the super capacitor reaches the voltage of the charging power supply, and then the charging module is turned off; and if the voltage difference is less than the second threshold voltage, the MOS field effect tube is turned off and the body diode is conducted, and the small-current charging mode is adopted and the charging power supply is controlled through the charging module to charge the super capacitor until the voltage across the super capacitor reaches the voltage of the charging power supply, and then the charging module is turned off.

When it is in the charged state during discharging, if the voltage difference is less than the second threshold voltage, the charging module is kept turned off until the voltage difference is greater than the second threshold voltage, then the charging module is turned on and small-current charging is adopted, and if the voltage difference tends to decrease, until the voltage across the super capacitor reaches the voltage of the charging power supply, the charging module is turned off; and if the voltage difference tends to increase and is greater than the first threshold voltage, the MOS field effect tube is turned on, and large-current charging is adopted until the voltage difference is less than the second threshold voltage, then the MOS field effect tube is turned off and the body diode is conducted, and small-current charging is adopted until the voltage across the super capacitor reaches the voltage of the charging power supply, and then the charging module is turned off.

When the voltage difference between the charging power supply and the voltage across the super capacitor is less than the second threshold voltage, since the voltage difference between the two is small, the charging current will also be small, which is about 0.6 A, the conduction voltage drop of the MOS field effect tube is about 0.4 V, and the loss is the product of voltage and current as follows: U×I=0.4 V×0.6 A=0.24 W, which indicates that the power consumption is small, and the MOS field effect tube will not be burnt out due to overheating.

When the voltage difference between voltages across the charging power supply and the super capacitor is greater than the first threshold voltage, the processor sends a conduction command to the MOS field effect tube. To ensure the effective conduction of the MOS field effect tube, there is generally a delay of 2-3 milliseconds before the charging circuit starts to operate.

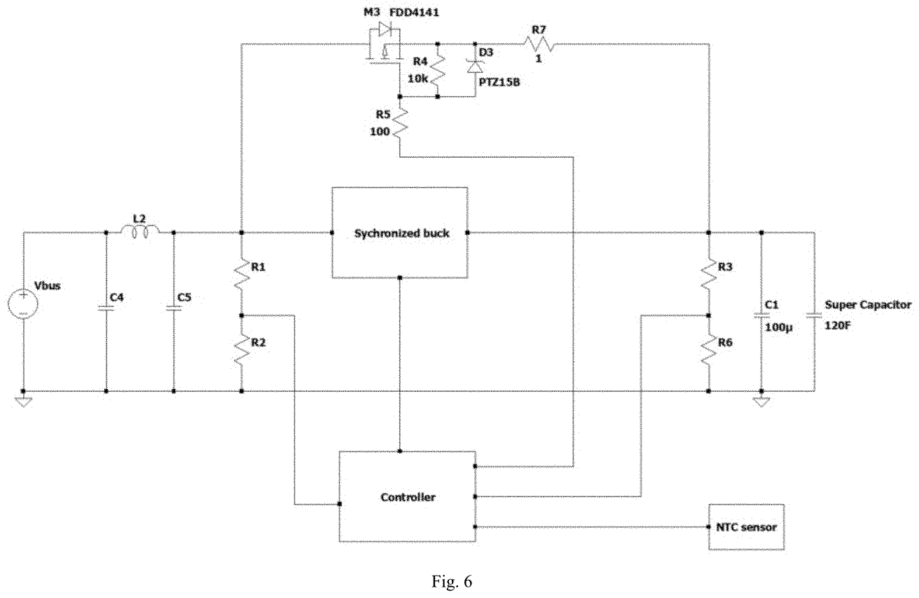

The above implementation is the implementation of the series approach, while the invention may also be implemented in a parallel approach. As shown in FIG. 6, the implementation and control logic are basically the same as described above, where when the small-current charging circuit starts working, the buck synchronized rectification current stops working, and vice versa, the buck synchronized rectification current starts working, and the hysteresis space of control and the strategy of changing with temperature use the methods described above.

Although specific implementations of the present disclosure have been described above, it should be understood by those skilled in the art that these are only examples, and various changes or modifications can be made to these implementations without departing from the principles and essence of the present disclosure. Therefore, the scope of protection of the present disclosure is defined by the appended claims.

What is claimed is:

1. A charging management method for an automotive electronic super capacitor, comprising:
detecting a voltage difference between a charging power supply and a super capacitor, and comparing the voltage difference with a first threshold voltage and a second threshold voltage, wherein the first threshold voltage is greater than the second threshold voltage;
according to a comparison result, by adopting constant-current charging and controlling a unidirectional conduction module to turn on, causing the charging power supply to charge the super capacitor through a charging module until a voltage across the super capacitor reaches a voltage of the charging power supply; and
turning off the charging module, wherein a low voltage difference is avoided in which case the super capacitor is discharged to the charging power supply through the charging module.

2. The charging management method for the automotive electronic super capacitor according to claim 1, wherein
when the super capacitor is in a pure charged state, if the voltage difference is greater than the first threshold voltage or is between the first threshold voltage and the second threshold voltage, large-current charging is adopted until the voltage difference is less than the second threshold voltage, then the unidirectional conduction module is turned on and small-current charging is adopted until the voltage across the super capacitor reaches the voltage of the charging power supply, then the charging module and the unidirectional conduction module are turned off; and when the voltage difference is less than the second threshold voltage, the unidirectional conduction module is turned on and small-current charging is adopted until the voltage across the super capacitor reaches the voltage of the charging power supply, then the charging module and the unidirectional conduction module are turned off; and
when the super capacitor is in a charged state during discharging, if the voltage difference is less than the second threshold voltage, the charging module and the unidirectional conduction module are kept turned off until the voltage difference is greater than the second threshold voltage, then the unidirectional conduction module and the charging module are turned on and small-current charging is adopted, and if the voltage difference tends to decrease, until the voltage across the super capacitor reaches the voltage of the charging power supply, the charging module and the unidirectional conduction module are turned off; and if the voltage difference tends to increase and is greater than the first threshold voltage, the unidirectional conduction module is turned off and large-current charging is adopted until the voltage difference is less than the second threshold voltage, then the unidirectional conduction module is turned on again and small-current charging is adopted until the voltage across the super capacitor reaches the voltage of the charging power supply, then the charging module and the unidirectional conduction module are turned off.

3. The charging management method for the automotive electronic super capacitor according to claim 2, wherein the first threshold voltage and the second threshold voltage are adjusted according to different temperatures of the super capacitor, wherein a difference between the first threshold voltage and the second threshold voltage tends to decrease as the temperature increases.

4. The charging management method for the automotive electronic super capacitor according to claim 3, wherein
when the temperature is higher than 20° C., the difference between the first threshold voltage and the second threshold voltage is set to 0.7-0.85 V, and
when the temperature is lower than 20° C., the difference between the first threshold voltage and the second threshold voltage is set to 0.85-1.5 V.

5. The charging management method for the automotive electronic super capacitor according to claim 4, wherein the difference between the first threshold voltage and the second threshold voltage is calculated using the following equation, and then the first threshold voltage and the second threshold voltage are adjusted according to the difference,
ΔV=0.9−0.01*T
wherein ΔV denotes the difference between the first threshold voltage and the second threshold voltage, and T denotes the temperature of the super capacitor.

6. The charging management method for the automotive electronic super capacitor according to claim 1, wherein the charging module is in a Buck topology, the second threshold voltage is set according to a voltage drop corresponding to the charging module when a maximum duty ratio is reached, and the first threshold voltage is set according to the second threshold voltage and a sum of line voltage drops corresponding to the super capacitor and a circuit except the charging module.

7. A charging management system based on the charging management method for the automotive electronic super capacitor according to claim 1, comprising: a processor, wherein the processor is connected to a temperature sensor, the charging module, and a voltage detection module; wherein
the charging module is connected to a switch control module and the unidirectional conduction module;
the switch control module is configured to control turn-on and turn-off of the charging module;
the charging module is used to implement charging of the super capacitor from the charging power supply;
the temperature sensor is configured to detect a temperature inside the super capacitor;
the unidirectional conduction module is configured to control unidirectional charging of the super capacitor by the charging power supply through the charging module; and
the voltage detection module is configured to detect the voltage of the charging power supply and the voltage across the super capacitor respectively in real time.

8. The charging management system for the automotive electronic super capacitor according to claim 7, wherein the switch control module is implemented using a metal oxide semiconductor (MOS) field effect tube, the unidirectional conduction module is implemented using a body diode of the MOS field effect tube, and the charging module is in a Buck topology, and
the processor is configured to receive the voltage of the charging power supply and the voltage across the super capacitor, calculate the voltage difference between the charging power supply and the super capacitor, and determine whether the super capacitor is in a pure charged state or in a charged state during discharging, wherein:
when the super capacitor is in the pure charged state, if the voltage difference is greater than the first threshold voltage or is between the first threshold voltage and the second threshold voltage, the MOS field effect tube is turned on, and a large-current charging mode is adopted and the charging power supply is controlled through the charging module to charge the super capacitor until the voltage difference is less than the second threshold voltage, then the MOS field effect tube is turned off and the body diode is conducted, and a small-current charging mode is adopted and the charging power supply is controlled through the charging module to charge the super capacitor until the voltage across the super capacitor reaches the voltage of the charging power supply, and then the charging module is turned off; and if the voltage difference is less than the second threshold voltage, the MOS field effect tube is turned off and the body diode is conducted, and the small-current charging mode is adopted and the charging power supply is controlled through the charging module to charge the super capacitor until the voltage across the super capacitor reaches the voltage of the charging power supply, and then the charging module is turned off; and
when the super capacitor is in the charged state during discharging, if the voltage difference is less than the second threshold voltage, the charging module is kept turned off until the voltage difference is greater than the second threshold voltage, then the charging module is turned on and small-current charging is adopted, and if the voltage difference tends to decrease, until the voltage across the super capacitor reaches the voltage of the charging power supply, the charging module is turned off; and if the voltage difference tends to increase and is greater than the first threshold voltage, the MOS field effect tube is turned on, and large-current charging is adopted until the voltage difference is less than the second threshold voltage, then the MOS field effect tube is turned off and the body diode is conducted, and small-current charging is adopted until the voltage across the super capacitor reaches the voltage of the charging power supply, and then the charging module is turned off.

9. The charging management system for the automotive electronic super capacitor according to claim 7, wherein the unidirectional conduction module is implemented by adopting a small-current charging mode, and is controlled in parallel with synchronized rectification Buck current.
